(19) United States
(12) Patent Application Publication
(10) Pub. No.: US 2007/0005564 A1
(43) Pub. Date: Jan. 4, 2007

(54) Method and system for performing multi-dimensional searches

(76) Inventor: Mark Zehner, Jackson, MI (US)

Correspondence Address: DICKINSON WRIGHT PLLC, 1901 L. STREET NW, SUITE 800, WASHINGTON, DC, 20036, US

(21) Appl. No.: 11/262,928

(22) Filed: Nov. 1, 2005

Related U.S. Application Data
(60) Provisional application No. 60/694,807, filed on Jun. 29, 2005.

(51) Int. Cl. G06F 17/30

(52) U.S. Cl. 707/2

(57) ABSTRACT

The present invention is a search engine and method of performing a multi-dimensional search with a computer, including creating a directory database comprising site information, said site information comprising addresses for a plurality of web sites, a role for each said plurality of web sites, and a rating for each said plurality of web sites; receiving a first query; performing a search of said directory database based on at least one role for each of said plurality of websites, and at least one rating for each of said plurality of web sites; obtaining search results from the search of the directory database, said search results comprising an address for at least one of said plurality of web sites; and outputting the search results. Additional aspects include that the site information may include a category for each said plurality of web sites. Also, it may further comprise creating a secondary database, having a search results database or a cache database.

### CLAIM OF PRIORITY

This application claims a benefit of U.S. Provisional Application No. 60/694,807, filed Jun. 29, 2005

### FIELD OF THE INVENTION

The present invention generally relates to a semi-automated system and method to perform multi-dimensional searches of electronic databases, and more particularly to a system and method to determine the value of electronic data based on user ratings, desired page role and category, and use of synonyms and similar key phrases.

### BACKGROUND OF THE INVENTION

Researchers are creating a variety of methods to address the need to efficiently and accurately access electronically stored information. Current known methods for electronic information searching typically include: text or phrase searching based on key words, using interest profiles, then ranking and rating search results. For example, U.S. Pat. No. 6,823,333 to McGreevy describes a system that searches a database for subsets of the database that are relevant to an input query based on key terms (or phrase(s). U.S. Pat. No. 6,741,981, also to McGeevy, describes a phrase search system. U.S. Pat. No. 6,415,285 to Kitajima et al, describes a search program that stores a relationship between a key word and a particular database. U.S. Pat. No. 6,654,735 to Eichstaedt et al., describes an outbound information analysis technique for generating user interest profiles and improving user productivity. This system is used to “learn” a user's interests, which may be used to query diverse databases and internet web pages for information relevant to those interests.

U.S. Pat. No. 6,438,579 to Hosken provides a method for recommending search items to a user based on similarity between the user's and other user's profiles. U.S. Pat. No. 6,314,420 to Lang et al., provides content filter and ranking with a user feedback system. This system, though, appears to lack ability to rate previously unsearched material.

Also generally known in the art are methods currently used under the trade name GOOGLE that include a combination of determining ordering of search results based both on the strength of the search phrase match and the previously determined “importance” of the page or information. Both the importance of the page and match criteria are influenced by inbound links (i.e., links from another web site or domain that point to the page under evaluation for importance) and the wording used in the inbound links.

Despite the usefulness and effectiveness of currently known electronic search capabilities, there are several potential ways that may make these systems better. For example, there appears in the art to be a lack of ability to judge quality of searched content accurately, an inability to filter content based on the role or function of the content, an inability to filter content based on the category of the content, and an inability to expand the search based on use of synonyms and similar key phrases. In the past, “robots” (i.e., programs that search through content on the internet, and automatically save the information in a database along with evaluating content and page importance) have measured content of information based on inbound links and phrases used in these links. People calling themselves Search Engine Optimization (SEO) experts have studied these automated search engine operations and have optimized search placement by adjusting content to obtain an artificially increased placement or ranking.

Other means to confuse ranking (i.e., not based on actual merit or content) are known. For example, many webmasters pay to have sites link to them. Others may exchange links with other sites by requesting a link exchange using emails. There are many services that provide for sending email on behalf of webmasters to get other sites to link to them. The net result is that a searcher receives an inaccurate search result because sites having information with greater relevant content have not necessarily been given an appropriate ranking. In addition, the current system causes an SEO game to be played where search engines refine their techniques to determine a value of data while the webmasters and SEO experts refine their methods. This results in a great deal of wasted effort for all parties concerned and the internet user suffers since the webmasters concern themselves more with the placement of their data rather than the actual value of what they produce. In short, there is no known method or system to overcome these obstacles utilizing a completely automated process to determine page value and appropriate ranking.

Thus, there is a need in the art for a new system that will determine information importance based on user ratings, allow searches to be refined by page role and category to eliminate unrelated results to that desired, and allow for additional results based on synonyms and similar key phrases. This will produce more accurate and useful search results for the searcher and indirectly increase the quality of information made available by the internet community.

### SUMMARY OF THE INVENTION

Accordingly, it is an important aspect of the invention to provide a method and system to rank and return search results that are influenced by a predetermined user perception of the quality of the content.

An important aspect of the invention is the reduction of undesired search results by using site role and site category as a determining factor when determining possible matches.

In accordance with another aspect of the invention, the use of synonyms and similar key phrases can be used to expand the search to include more relevant results so the searcher does not need to enter multiple search queries to find relevant information.

Briefly, the invention provides a method and system to allow search results to be influenced by user perception of content quality and reduce irrelevant content while including some relevant content not normally included.

The present invention is a search engine and method of performing a multi-dimensional search with a computer, including creating a directory database comprising site information, said site information comprising addresses for a plurality of web sites, a role for each said plurality of web sites, and a rating for each said plurality of web sites; receiving a first query; performing a search of said directory database based on at least one role for each of said plurality of websites, and at least one rating for each of said plurality of web sites; obtaining search results from the search of the directory database, said search results comprising an address for at least one of said plurality of web sites; and outputting the search results.

Additional aspects include that the site information may include a category for each said plurality of web sites. Also, it may further comprise creating a secondary database, having a search results database or a cache database. The cache database may optionally contain a cache of web sites from the directory database. The search may add checking the validity of web sites, said checking comprising locating web sites listed in the directory database.

Additional aspects and advantages of the invention will become apparent from the following detailed description, the drawings, and the appended claims.

### BRIEF DESCRIPTION OF THE FIGURES

The foregoing features, as well as other features, will become apparent with reference to the description and figures below, in which like numerals represent like elements, and in which:

FIG. 1 illustrates a summary block diagram in accordance with one possible embodiment of the present invention including the directory of web sites and search engine with basic information flow between the various parts and users including the searcher, search engine administrator, directory site administrators, and webmasters submitting sites to the directory.

FIG. 2 illustrates a block diagram in accordance with one possible embodiment of the present invention including entity cooperation between the directory and search engine detailing data information that each may share.

FIG. 3 illustrates a possible set of databases that may be required by the present invention and data flow between them covering the directory database, temporary cycle database used while crawling web pages, the temporary site database used to store pages from specific sites, the cache database which is the primary database for the search engine, the search results database, where search results may be stored, and the synonym database which may be used to expand the search criteria.

FIG. 4 illustrates a possible directory database, potential users and how each group might use it.

FIG. 5 illustrates potential search processing of the present invention from when the searcher specifies search criteria to the search device, which databases are queried, where the results are returned from, and where result information may be stored.

FIG. 6 illustrates potential robot crawler data sources of the present invention showing the robot crawler relationship with its data sources and what the robot crawler does.

FIG. 7 illustrates a flow chart of the beginning and end of a potential crawler cycle of the present invention.

FIG. 8 illustrates a continuation of the flow chart illustrated in FIG. 7 from point G of a potential crawler loading pages, checking for errors, and putting links in the domain database.

FIG. 9 illustrates a possible flow chart of a search engine crawler of the present invention checking to see if a link is already listed in the domain database.

FIG. 10 illustrates a potential flow chart of a search engine crawler of the present invention checking for abuse of key words or the role metatag by webmasters.

FIG. 11 illustrates a potential flow chart of a crawler of the present invention checking for hidden content and dense key words, preparing to save content, and saving content in the domain database for HTML pages.

FIG. 12 illustrates a potential flow chart of a crawler of the present invention preparing to save content, deriving title and description values, and saving content in the domain database for text pages.

FIG. 13 illustrates a potential flow chart of a search process of the present invention that happens when a user begins a search at a search engine using the invention.

FIG. 14 illustrates a potential site rating form of the present invention.

FIG. 15 illustrates a potential Site Submission Page form of the present invention.

### DETAILED DESCRIPTION OF THE INVENTION

The present invention relates to a new system and method to automatically determine information importance based on user ratings, allow searches to be refined by page role and category to eliminate unrelated results to those desired, and allow for additional results based on synonyms and similar key phrases. This will produce more accurate and useful search results for the searcher and indirectly increase the quality of information made available to the internet community.

The following discussion provides a brief general description of a suitable computing environment in which the present invention may be implemented. Although not required, the invention will be described in the general context of computer-executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate the invention may be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Memory storage devices may include a hard disk, a magnetic disk, optical disk, and the like. It should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs), and the like may also be used in the exemplary operating environment.

A personal computer utilizing the present invention may operate in a networked environment using logical connections to one or more remote computers, such as a remote computer. The remote computer, such as a service provider computer may be another personal computer, a server, a router, a network PC, a peer device or other common network node, and typically includes many or all of the elements described above relative to a personal computer. The logical connections depicted in the figures may include a local area network (LAN) and/or a wide area network (WAN). Such networking environments are commonplace in offices, enterprise-wide computer networks, intranets, and the Internet.

It should be noted that the computer system described above can be deployed as part of a computer network, and that the present invention pertains to any computer system having any number of memory or storage units, and any number of applications and processes occurring across any number of volumes. Thus, the present invention may apply to both server computers and client computers deployed in a network environment, having remote or local storage.

One embodiment of the present invention may be developed primarily for an Internet-based system, but it should be realized by those skilled in the art that other types of systems are possible, such as an internally operated intranet. Such systems are currently in place in very large corporations.

To more adequately understand the present invention, a brief discussion of the Internet may also be useful. The Internet (i.e., World Wide Web, “web”, and “www”) is extremely popular due to the large amount of shared information and the ease of obtaining such information. Most pages on the internet are in a viewable form called Hyper Text Markup Language (HTML). HTML is very similar to normal text except it uses tags mixed within the normal text to define text formatting for items such as tables, paragraphs, lists, and even. characteristics of the letters such as whether the characters are underlined, in bold font, the font used, and the size of the text characters. An HTML “page” can be read by a special program called a “web browser”. Pages may be located at many places on the internet. The complete location of the page is called the universal resource location (URL) and is normally seen in the internet browser in the address bar. All pages are stored on different internet “domains”, which may be owned by an individual or company. An example of an internet domain currently in use is one operated under the service names GOOGLE.COM or MYDOMAIN.COM. Pages and items stored on one domain collectively are called a “web site”.

HTML pages are text pages that contain “tags” to identify items included in the text. These tags specify items such as paragraphs, headers, tables, ordered or unordered lists, and the like. These tags indicate where the item begins and ends. In addition to tags, each of these HTML pages contains headers that can specify additional information about a web page, which the user may not normally see. Some of these tags are called “metatags” and are included in an area near the top area of the HTML page called the header. Some metatags items include a title, page description, and keywords. The content of the meta tags may be used by search engines to help determine the relevance of each page to any particular search phrase.

The main tool used on the internet today to identify desired web page content is called a search engine. Search engines may use special programs called “crawlers” to find such pages on the internet, retrieve them, and store them in the memory or database on one or more of the search engine's servers. A search engine appears to a user as a specific web site that allows them to enter search phrases in a text box and send the phrase to the search engine web site. Upon request, the search engine looks through its library of saved web pages which may be in a database, and determines the “best” match or matches, then returns the results to the user.

Some search engines consider the use of links pointing to a page, called inbound links, including the title of the link to assist in determining the value (or score) of a page relative to specific search terms. The page scores a value based on the search term and also has a value determined by link structure. Conventional thinking is that webmasters will link to pages they consider useful, so statistically the better quality pages will have a better value and appear more prominently in the search results.

While these current search engines are useful, there exists a need to improve the quality of these search results. Accordingly, the present invention provides a qualitatively superior method and system for performing searches of information available on the internet or a computer network. This system is designed to provide more accurate search results by eliminating non relevant matches with a multidimensional search, while including similar words or phrases in the search query to include relevant matches not normally included. This system will also increase accuracy by providing a more accurate means of measuring content value with semi-automated configurations rather than fully automated configurations. This multidimensional search is based on site or data function, along with the subject of the page content. The system will allow the returned search result page list order to be affected by a predetermined reputation input of the sites or data included in the search. This present invention generally operates in a distributed computing environment where computers are connected over a network or internet. The system could function on one computer system or on several computers as described above.

More specifically, the present invention generally relates to a system and method to use semi-automated configurations to determine a value of data or information in storage media irrespective of whether it resides on the internet or some other stored location. By using this semi-automated system to determine data value, the value of the information returned to the search result should be of a better quality than previously known in the art and those producing information can return to addressing the quality of their information. Illustrations to demonstrate the improvements provided by the present system over the prior art, and not by way of limitation, include: the use of site or domain ratings by users (rather than using links to determine page value); the use of page or site role to eliminate results that are not the type of results the user is looking for; the optional use of directory site category for the associated page to eliminate search results based on subject; the use of synonyms and similar search phrases to include more relevant search results; and, the use of approved page key words in metatags combined with actual words on the page to be included as a relevant search result. This system results in a higher search value since more relevant information is included and more unwanted information is excluded.

The present system may be configured to allow input on site or domain ratings by users. This will make page importance more accurate assuming user rating system fraud is minimized. The page importance may be used to help adjust or determine page listing order of returned results from the search.

The use of page or site role to eliminate results that are not the type of results the user is looking for will eliminate much irrelevant results and make the search more efficient and useful.

To illustrate the use of “page” or “site” role to limit search results may be described as follows. If a user is looking for documentation, tutorials, and articles, the system of the present invention may allow the option of filtering out search information related to products, services, statistics, events, other undesired roles, and the like. Page or site roles may include, but are not limited to, sites or pages providing links, articles, statistics, maps, tutorials, products, services, forums, chat, news, quizzes, polls, downloads, tools, events, pictures, video or video streaming, audio or audio streaming, reviews, price comparisons, listings, and searching.

The optional ability to search sites and pages of sites that are listed in a specific directory category indexed by topic may limit results to a specific area of information. For example, when a user is searching for technical information about computers, if they search in a category of “computers and internet” they will not receive undesired results from sites or pages on sites listed in other categories such as “arts and entertainment”.

The use of synonymous words and phrases will include more relevant search results. Equal weight may be given to pages providing similar content for the same purpose even though the phrase used on the searched page may be different from the search term. For example, and not by way of limitation, a searcher may search for “HTML tutorial”. Some titles on relevant pages may be “HTML tutorial” but other places the term “HTML guide”, “HTML documentation”, “HTML information”, “HTML manual”, and the like. The searcher should have the option of including the similar phrases and synonyms in their search rather than needing to search on every similar search phrase of which they can think. The present invention will allow for development and storage of such synonyms.

The use of approved page key words in metatags combined with actual text on the page to be included as a relevant search result will also make it easier for webmasters to have relevant information displayed in searches without having to be very verbose. For example, and not by way of limitation, if a user is searching on an operating system (such as one sold under the trade name LINUX) command called “chmod” many searchers may search on the term “LINUX chmod”. The webmaster may have created a page dedicated to chmod in a Linux tutorial but did not mention Linux on the page. Therefore, searches for “LINUX chmod” would not normally find this page relevant in the search. If the webmaster, however, uses the keyword “LINUX” in their meta tag for the “chmod” page, the search engine can realize that the page is relevant to LINUX and allow the page to appear in searches for “LINUX chmod”.

To support the invention, a typical embodiment may include one or more servers connected to a varying number of client computers over the internet or a network in a fashion well known in the art. Here, server computers provide an internet or network service that provides web pages to the client computers on demand.

Referring now to the figures, a preferred embodiment of the present invention is generally illustrated. The present invention is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

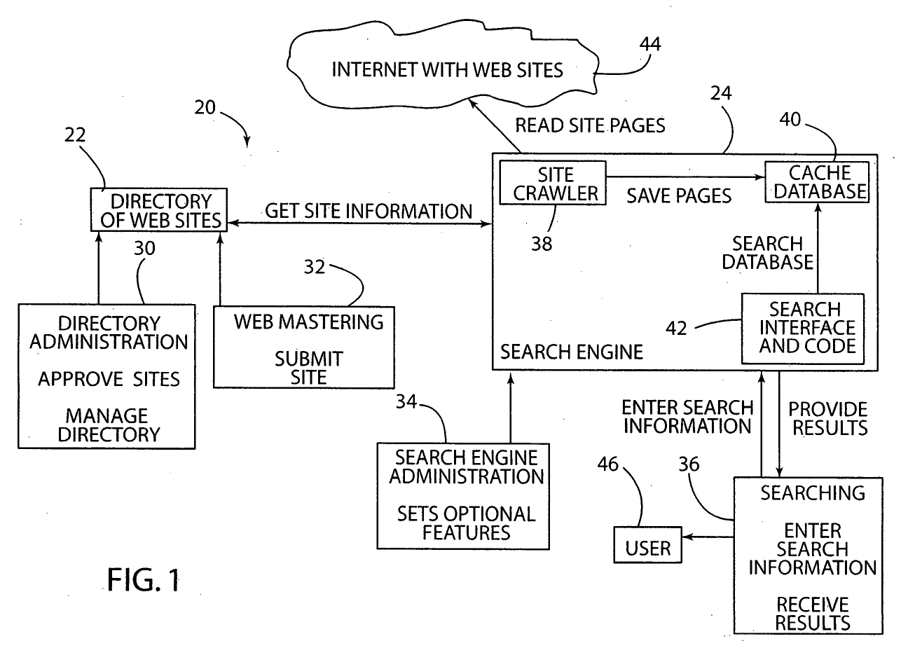

FIG. 1 illustrates one functional use of the invention. The present invention proposes a cooperative role (generally indicated at 20) between a website data directory 22 (contains site ratings, keywords, category the site is listed in, site roles provided) and search engine 24, where directory 22 shares information that supports search engine 24 and search engine 24 provides information back to directory 22 that aids management of directory 24. The invention requires both a directory 22 functionality (or web site) and a search engine 24 or search function object.

Directory database 22 is a database directory of sites that may contain data relating to: Site domain names; Functions or roles that the sites support; User ratings of sites; Key words associated with the site as agreed by the directory web site staff and webmaster of the submitted website; Categories for all sites to be listed in where one site is listed in only one category.

FIG. 1 also illustrates basic information flow between the various parts and user functions such as for directory administration 30 functions, webmastering 32 functions, search engine administration 34 functions, and searching 36 functions. FIG. 1 shows a directory administration 30 including approving sites and managing a directory of web sites. It shows a webmastering 32 functions including submission of site to directory 22, which directory 22 administrator may modify, approve, or reject. It also shows a search engine administration 34 functions including setting optional features of search engine 24. It shows searching function 36 including entering information and receiving results. Search engine 24 includes three primary subsections functions including the site crawler 38, cache database 40, and search interface and program code 42. Cache database 40 is a database of cached web pages from sites listed in the directory database. It contains a cache of the pages crawled on sites listed in the directory, includes the role or roles of each page, possibly includes page rank relevance information based on various popular searches, possibly contains popular searches. Specifically, cashed web page database 40 may contain: A cache of the pages crawled on sites listed in the directory with information stored based on text size (normal, H1, H2, H3, etc.); The role of each page; The value of each page. Basically, by way of example, site crawler 38 receives information from directory 22 about sites to be crawled and then going to the internet 44 and crawling those sites. Site crawler stores the crawled results in cache database 40. Search interface and program code 42 are shown searching cache database 40 on behalf of searching function 36 and then providing results to user 46.

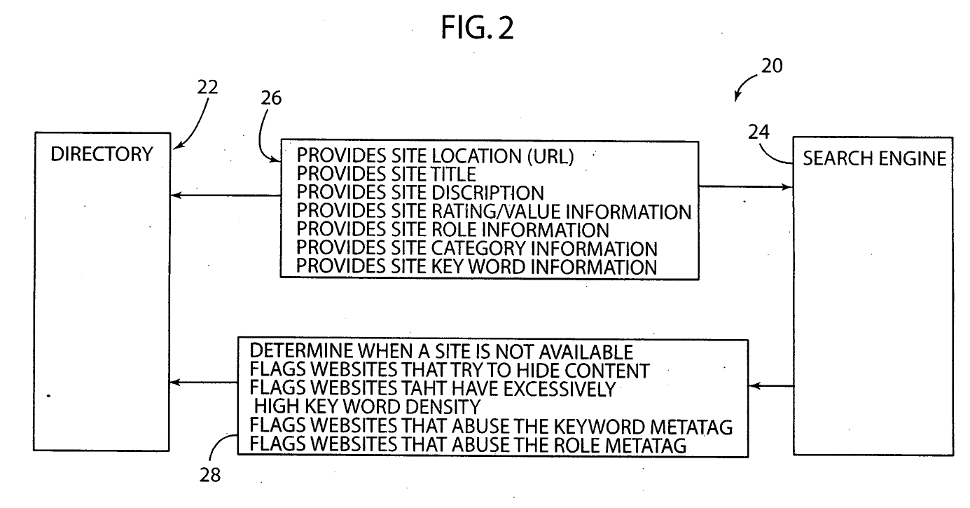

As shown at 26 in FIG. 2, information flow from 22 directory to search engine 24 may include: site location (URLs), site title, site description, site rating and value information, site role information, site category information, and site key word information to the search engine. As shown at 28, information from search engine 26 to directory 22 may include information about: when a site is not available on the internet, information about sites that hide content, information about sites that have high key word density, information about web sites that abuse the keyword metatag, and information about web sites that abuse the role metatag. This cooperative method works to better prevent fraud and produce a semi-automated method for more accurate searches.

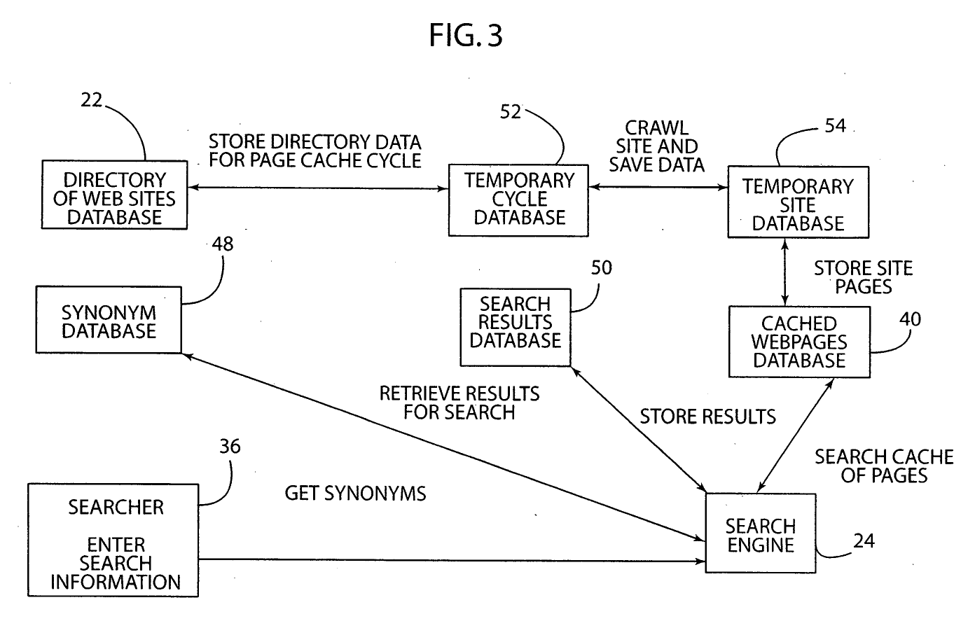

The present method and system may involve a flow of information around one database or several databases. As shown in FIG. 3, such databases include in addition to website directory 22: a synonyms database 48 having similar matching phrases for search queries, which may be used to expand the search criteria; a cached web pages database 40 of cached web pages, the primary database for search engine 24, from sites listed in the directory database of sites; an optional search results database 50 which can speed up search queries for queries done recently; a temporary cycle database 52 used to help build the database of cached web pages; and a temporary site or domain database 54 of paged crawled on a given web site or domain. Temporary site database 54 may be used to aid the finding and caching of all web pages on a site or domain. Other components may include internet web site crawler 38 that will find pages and store them in the cached web pages database 40 and a user interface allowing the user to search using site roles and subjects and optional use of synonyms or similar search phrases.

FIG. 3 shows the information being built and placed into the temporary site database 54 as data from the temporary cycle database 52 is used to determine sites to crawl. Data about the site pages is shown being moved from temporary site database 54 into the permanent cache database 40. A searcher 36 may enter search information and send it to search program 24. As illustrated, search results database 50 is shown being queried by the search program 24 as it attempts to retrieve results relevant to the current search. Search program 24 is shown getting synonyms from the synonym database 48, next searching the cache database of pages, and storing results in search results database 50. [We need to consider that the flow between the illustrations is both ways]

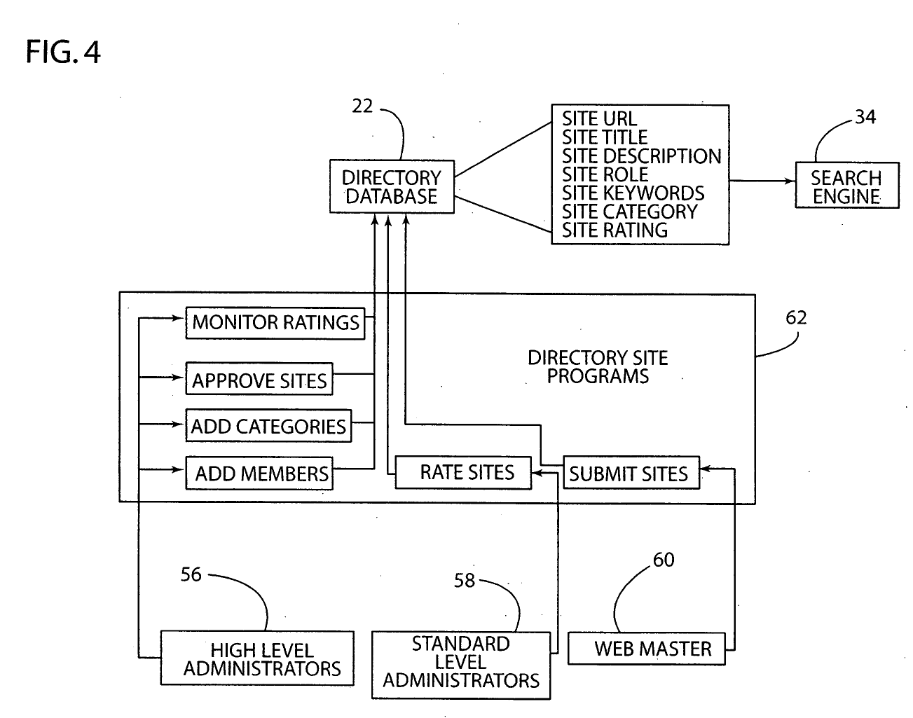

FIG. 4 illustrates possible directory database systems 62 configuration, the groups of people designated use it, and how each group will use it. In this configuration the system assigns a predetermined designation for that user, thus allowing access to various predetermined programs. For example, designated high level administrators 56 may monitor site ratings, approve submitted sites, adding categories, and adding members to the directory database. Designated standard level administrators 58 may rate sites in directory database 22. Designated Webmasters 60 are not members of the directory are shown submitting sites to the directory database. These activities are shown being done using directory site programs 62, which are shown interfacing with directory database 22 to add or modify information in directory database 22. Directory database 22 is shown providing information to search engine 34, which may include site URL, site title, site description, site roles, site key words, site category, site ratings, and the like.

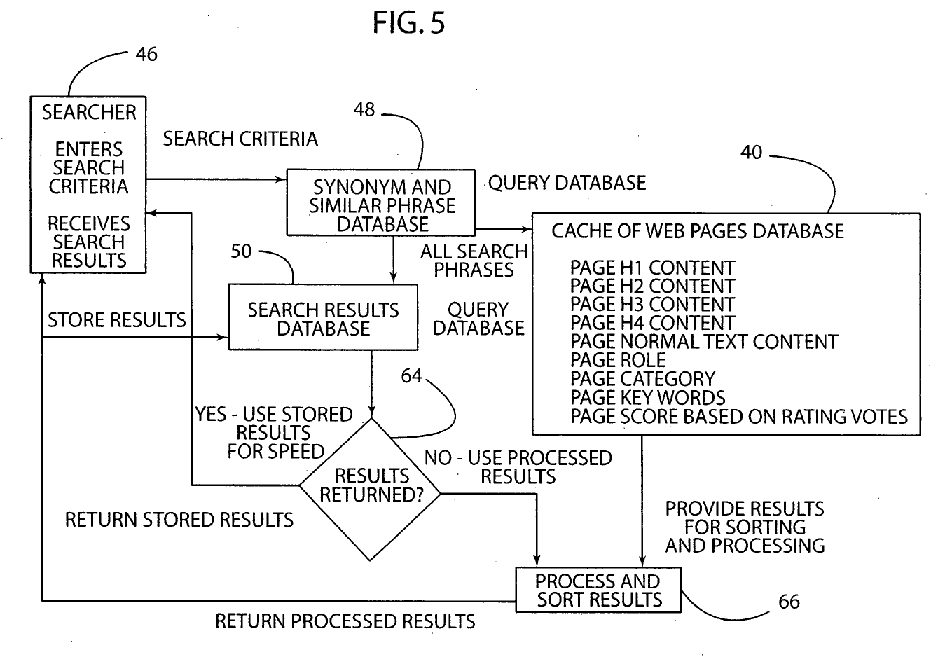

FIG. 5 expands and illustrates possible search processing system of the search engine 24. This aspect, as illustrated, includes actions when a user/searcher 46 specifies search criteria to the search engine 24, which queries its configured and predetermined databases, where the results are returned from, and where result information may be stored. As shown user 46 enters search criteria into a synonym and similar phrase database 48 as shown in FIG. 3. From there a query is sent to both the search results database 50 and cache of web pages database 40. The cache of web pages data 40 is shown containing information about the pages stored including page header 1 sized content, page header 2 sized content, page header 3 sized content, page header 4 sized content, normal sized text on the page, page role, page category, page keywords, and page score based on rating votes. The query of the search results database 50 and the cache of web pages database 40 run simultaneously until it is determined whether the search results database 50 contains results that will help the search. A diamond shaped decision box is shown at 64 with output back to the user 46 being used from search results database 50 if search results database 50 successfully returns results. If search results database 50 does not return results, output of the query from the cache of web pages databases 40 is sent to a processor to process 66 and sort the results of the query. The processed and sorted results 66 are both stored in the search results database 50 for future reference and provided to the searcher.

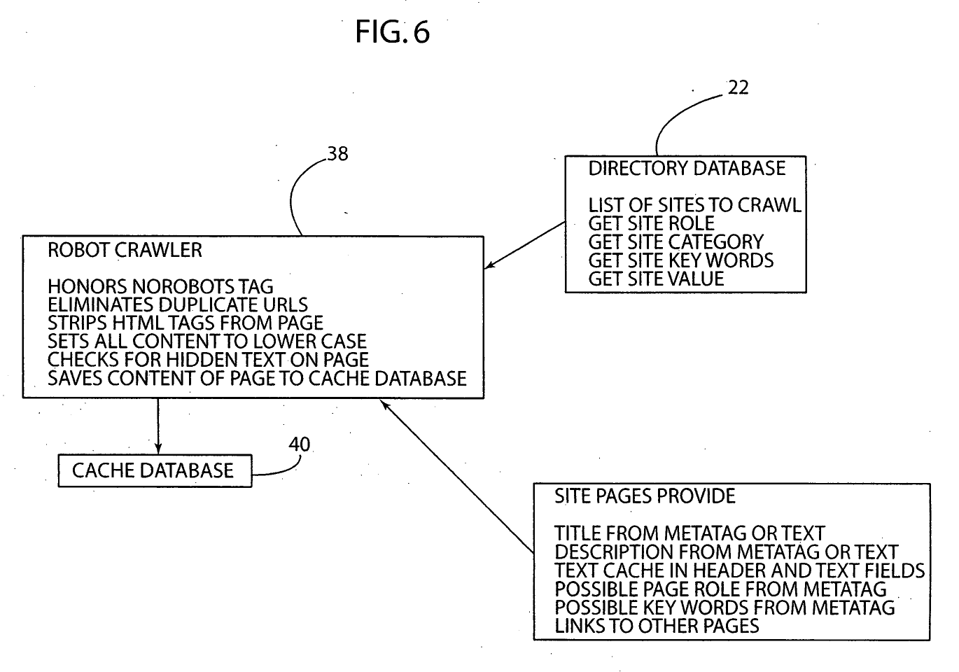

FIG. 6 illustrates possible robot crawler 38 data sources showing the robot crawler 38 relationship with its data sources and functions of robot crawler 38. Robot crawler 38, directory database 22, site pages 22 with what they provide, and cache database 40 and their relationships are depicted in the figure. Robot crawler 38 as shown is reading the directory database 22 getting a list of sites to crawl and getting the site role, site category, site key words, and site value information. Robot crawler 38 is also shown getting information from site pages 22 including, by way of example, a title from a metatag or text on the page, a description of the page from a metatag or text on the page, copies of text that is stored in header fields or normal text fields based on the size of the text, and links to other pages. Robot crawler 38 is also shown possibly getting page role from a metatag on the page and possibly getting key words from a metatag on the page. Robot crawler 38 is shown processing this information from the directory database and web pages read. It is shown processing web page information while honoring the norobots tag, eliminating duplicate URLs, stripping HTML tags from the page, setting all content to lower case, checking for hidden text on the page, and saving the contents of the page or pages to cache database 40. The final action shown being performed by robot crawler 38 is saving the information from the site pages crawled to the cache database 40.

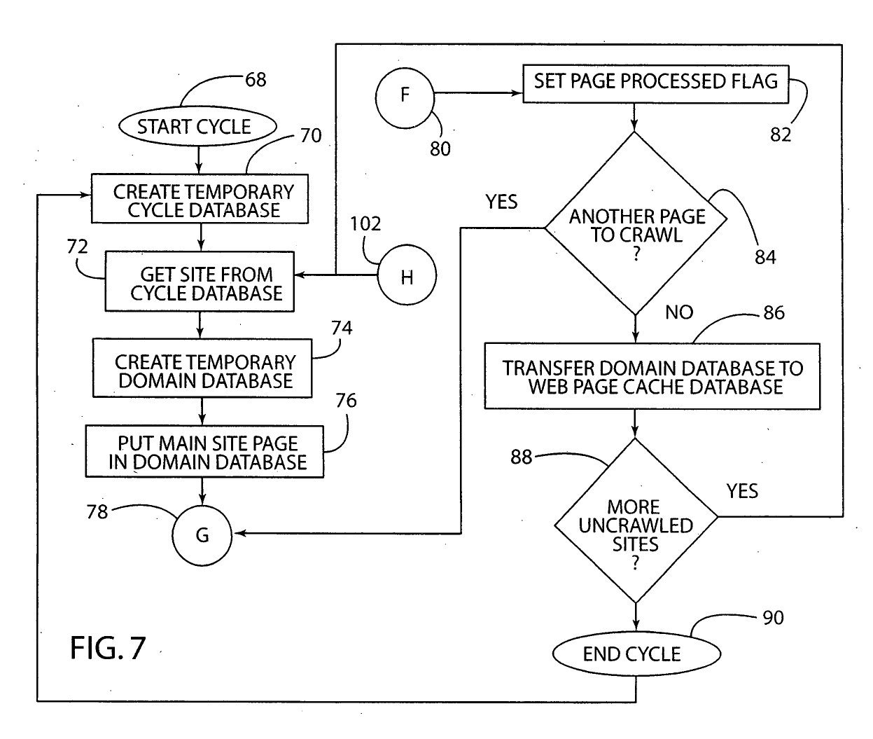

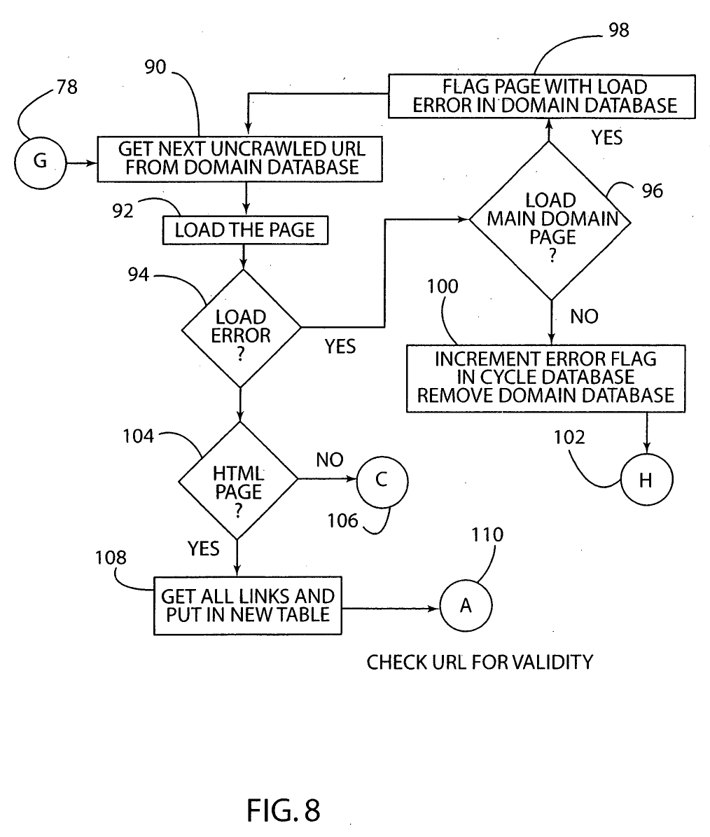

FIG. 7 illustrates a possible flow chart of the beginning and end of a potential crawler cycle utilizing the systems and methods of the current invention. The system starts at 68. Initially in step 70 the system creates a temporary cycle database and proceeds to step 72. At step 72, the system obtains site information from the temporary cycle database, proceeding to step 74 to create a temporary domain database used to store data from web pages on the site or domain. Then the main site page is shown being put into the temporary domain database at step 76. This ends the start of the cycle and a line to item G at 78 is shown which is continued on FIG. 8.

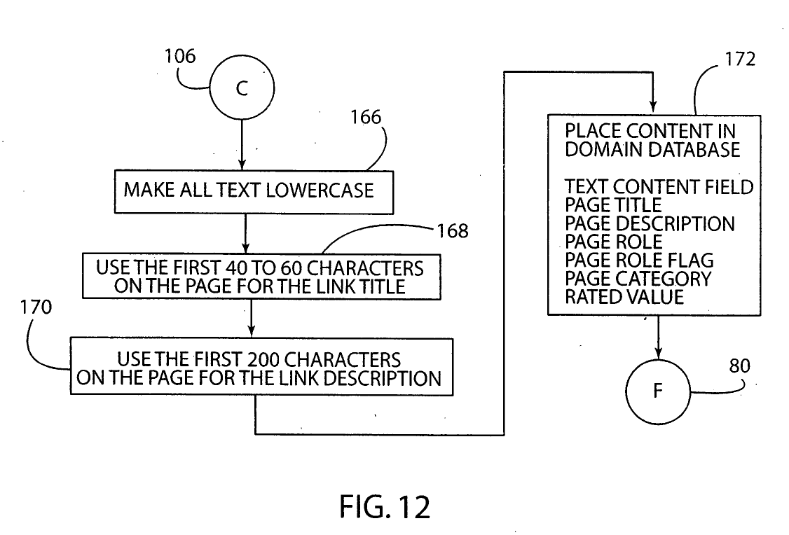

The continuation toward the end of the cycle continues on from F 80, which is a continuation from FIG. 12, at which point a page processed flag is set at step 82. The system then proceeds to step 84 to determine whether another page is available to crawl in the temporary domain database. If there is, the system proceeds to item G 78 to repeat the cycle. If no pages left to crawl, the temporary domain database is transferred to the web page cache database at step 86. Next, the system proceeds to step 88 to determine whether there are more uncrawled sites in the temporary cycle database. If there are no more uncrawled sites, the system proceeds to end at step 88 where it can return to step 70 and begin again with another creation of a temporary site database. If there are more uncrawled sites at step 88, the system proceeds back to step 72 to get another site to process from the temporary cycle database.

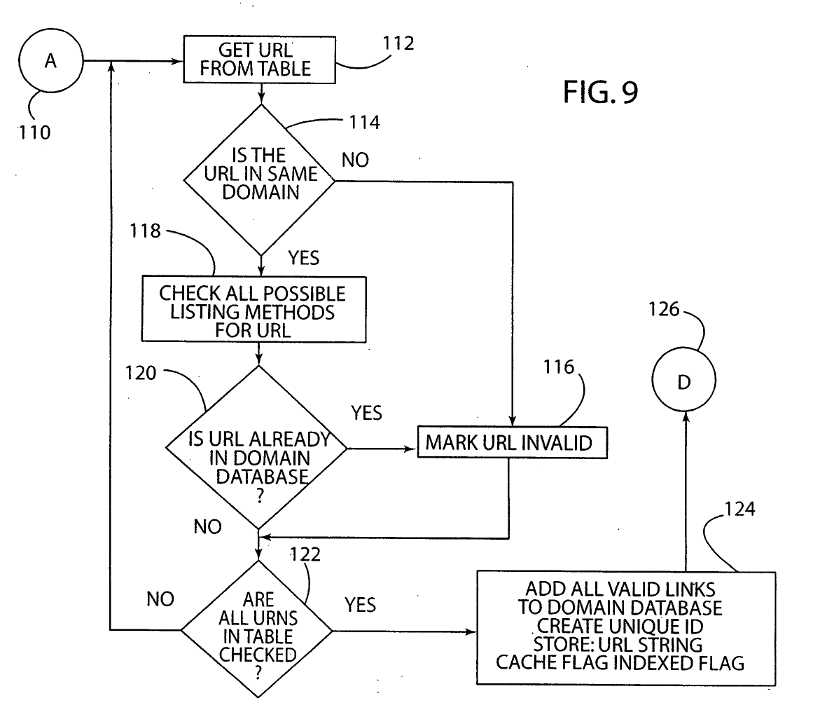

FIG. 8 illustrates a possible flow chart of crawler loading pages, checking for errors, and putting links in the domain database. It is a continuation of the system starting at point G 78 in FIG. 7. It shows the next uncrawled URL being retrieved from the temporary domain database at step 90, proceeding to step 92 where the page the URL points to is loaded. Next the system proceeds to step 94 to determine whether there is a load error. If yes, the system proceeds to step 96 to determine whether the main domain page can be loaded. If yes, i.e., the main domain page can be loaded, the system proceeds to step 98 and flags the page with the load error in a domain database in directory of web sites 22, then returns to step 90. If no, i.e., the main domain page cannot be loaded, the system proceeds to step 100 an error flag in the temporary cycle database is incremented and the domain database is removed. From step 100, the system proceeds to H 102 in FIG. 7 where site information is retrieved from the temporary cycle database in step 72. If the main domain page can be loaded, the page that was unsuccessfully loaded earlier is flagged indicating a load error in the temporary domain database. Then the flow loops back next to item G 78 where the next uncrawled URL is retrieved from the domain database. Going back to step 94, if a load error did not occur, the system proceeds to step 104 to determine whether the loaded page is an HTML page. If not, the system continues to item C 106 illustrated in FIG. 12. If the page is an HTML page as determined at step 104, the system proceeds to step 108 where all links on the page are retrieved and placed in a new table then the flow proceeds to Item A in FIG. 9 to check the URL for validity.

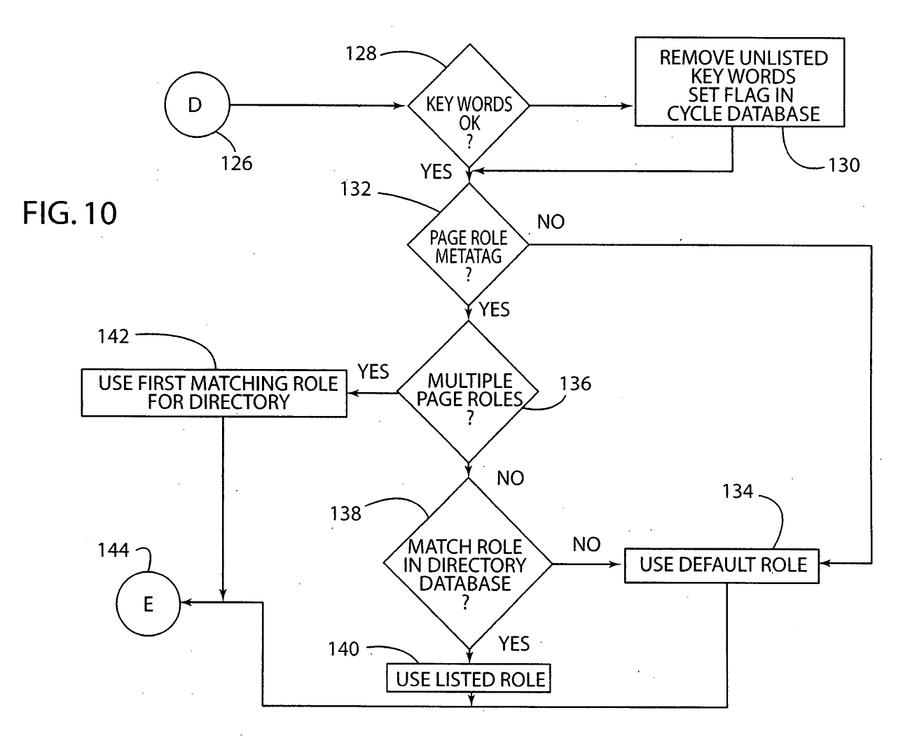

FIG. 9 illustrates a possible flow chart of Item A 110, a search engine crawler 24 checking to see if a link is already listed in domain database 22. Here the system at step 112 first obtains an unchecked URL from the table (see step 108). Next the system proceeds to step 114 to determine whether the URL is in the same domain as the web site. If not, the system proceeds to step 116 and the URL is marked invalid and proceeds to step 122. If the URL is in the same domain, the system proceeds to step 118 where it checks all possible listing methods for the URL then proceeds to step 120 to determine whether any possible listing method for the URL is already in domain database 22. If it is already listed, the system proceeds to step 116 and the URL is marked as invalid. If the URL is not in the temporary domain database, the system proceeds to step 122 where a determination is made whether all URLS in the table have been checked for validity. If not, the system proceeds back to step 112. If all URLs in the table have been checked, the system proceeds to step 124 where all valid links in the URL table are added to the temporary database. When this is done a unique URL identifier (ID) is created, the URL string is stored, a cached flag is created and stored with a value of 0, and an indexed flag is created and stored with a value of 0. The flow continues to item D 126, which is illustrated in FIG. 10.

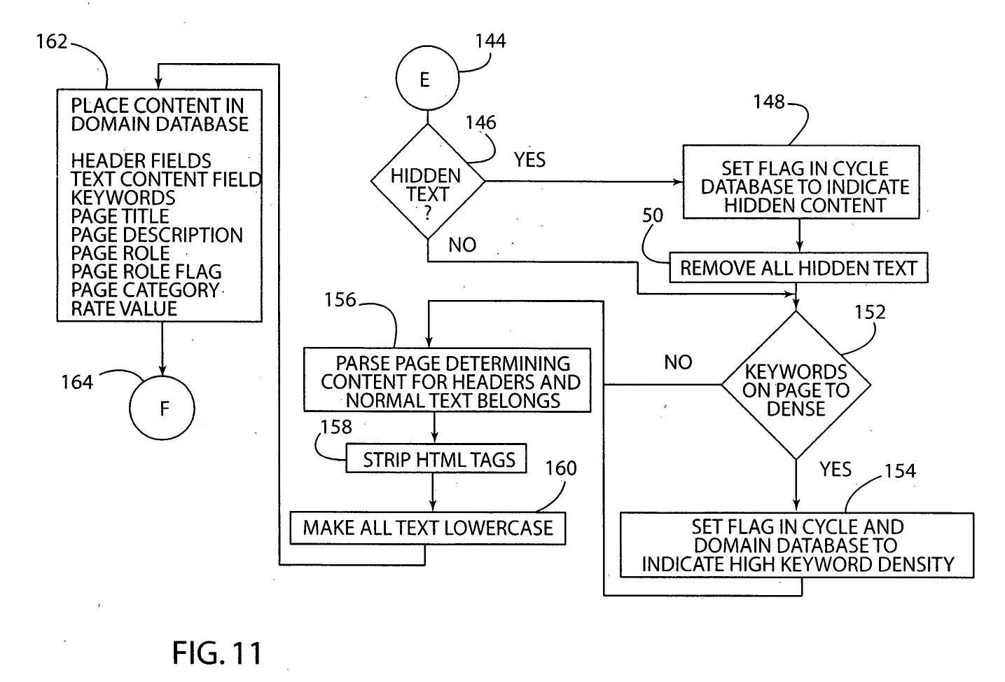

FIG. 10 continues item D 126 from FIG. 9 and illustrates a possible system flow of the search engine crawler 24 to check for abuse of key words or the role metatag by webmasters. It starts at Step 128 where key words on the page are checked against the information about the domain keywords from the temporary cycle database. If the key words are OK, the system proceeds to step 132. If the key words are not OK, unlisted key words are removed and a flag in the temporary cycle database is set to indicate the webmaster of the site tried to use key words not listed in the directory database at step 130, then proceeds to step 132. Next, the system proceeds to step 132 to determine whether there is a page role metatag. If one does not exist, the system proceeds to step 134 where a site default role from the temporary cycle database is used for the role of the page, then proceeds to Item E 144, discussed below and illustrated on FIG. 11. If a page role metatag exists, the system proceeds to step 136 to determine whether multiple page roles are listed in the tag. If there are multiple roles, the system proceeds to step 142 and the first role that matches the directory as listed in the temporary cycle database is used, then proceeds to Item E 144. If there is only one role listed in the page role metatag, the system proceeds to step 138 to determine whether it matches a role in the directory database. If it does not match a role in the directory database, the system proceeds to step 134 and a site default role from the temporary cycle database is used for the role of the page. If it does match a role in the directory database, the system proceeds to step 140 where the listed role is used then proceeds to Item E 144. Whether the listed role, default role, or first matching role from the directory are used for the page role, the flow of the figure continues to item E and illustrated in FIG. 11.

FIG. 11 illustrates a possible flow chart of the crawler checking for hidden content and dense key words, preparing to save content, and saving content in the domain database for HTML pages. First, at step 146, the page is checked to determine whether there is hidden text on it. If yes, the system proceeds to step 148 and a flag is set in the temporary cycle database indicating hidden text was found on the site. Next, at step 150, all hidden text is then removed. If hidden text was not found in step 146, or hidden text was removed at step 150, the system proceeds to step 152 where page is checked to determine whether keywords on the page are too dense which is indicated by a decision diamond figure. If keywords are too dense, the system proceeds to step 154 where a flag is set in the temporary cycle database indicating keyword density was too high on the web site. If keywords are not too dense, or after step 154, the system proceeds to step 156 where the page is parsed to determine where content for headers and normal text should be stored. Then HTML tags are stripped at step 158. The system continues to step 160 where all text is made lowercase. The flow continues to step 162 where all content from the page is placed into the temporary domain database. This content includes header fields, the text content field, the page title, the page description, the page role, the page role flag, the page category, and the rated value of the page. From here the system flow then continues to Item F 164, which is illustrated in FIG. 7, described above.

FIG. 12 illustrates a possible system flow of site crawler 38 preparing to save content, deriving title and description values, and saving content in the domain database for text pages. It begins with Item C 106 from FIG. 8. At step 166 all text is made lowercase in the first box. Next at step 168, the first 40 to 60 characters on the page are used for the link title. Next at step 170, the first 200 characters on the page are used for the link description. Next at step 172, content is placed in domain database 22, which includes the text content field, the page title, page description, page role, page role flag, page category, and rated value of the page. The next proceeds to item F 80, which is illustrated in FIG. 7.

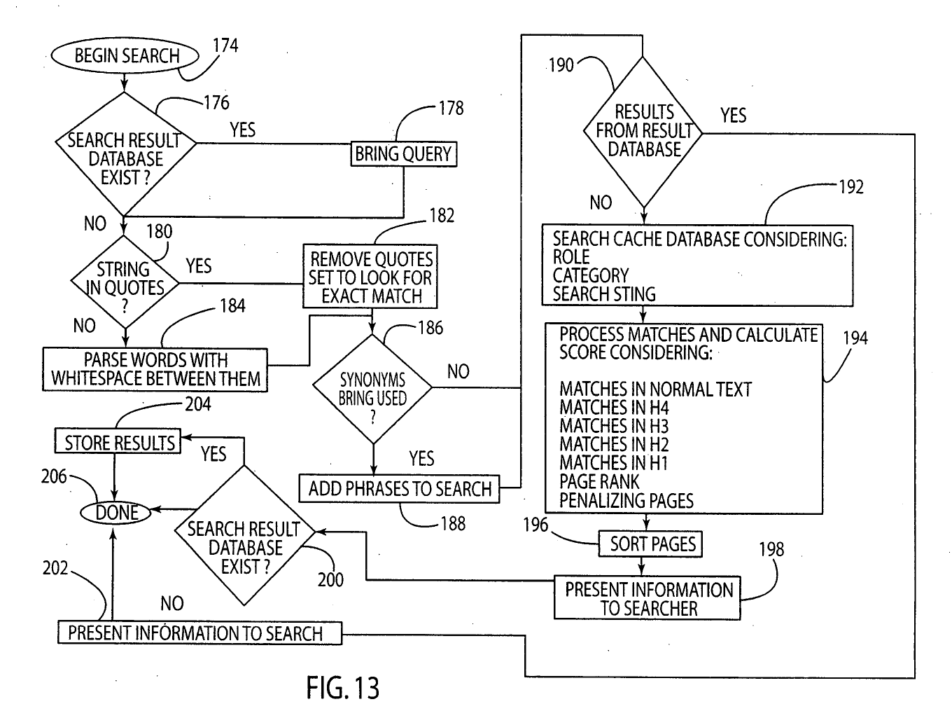

FIG. 13 illustrates a possible flow chart of the present invention in use. A user begins a search at step 174 at a search engine using the invention. When the search begins, a test is done at step 176 to determine whether a search result database exists. If yes, the system proceeds to step 178 where a query is sent to it with the search information and proceeds to step 180. If it does not exist or after the search result query was sent, a test is performed at step 180 to determine whether any part of the search string is in quotes. If yes, the system proceeds to step 182 where the quotes are removed and an indicator is set to indicate an exact match is desired for that part of the query, then proceeds to step 186. If no, the system proceeds to step 184 where part of the string is in quotes, words with white space between them are parsed to be separate, then proceeds to step 186. At step 186 a test is performed to determine whether synonyms are being used for the search. If yes, the system proceeds to step 188 where any appropriate phrases based on synonyms or similar key phrases are added to the search criteria and proceeds to step 190. If not, the system proceeds to directly to step 190 whether the system determines whether results from the result database are being provided. If yes, the system proceeds to step 202 where information is presented to the searcher and the process is done. If not, the system proceeds to step 192 where the cache database is searched considering the role of the pages, category of the pages, and search string from the searcher. Next, the system proceeds to step 194 where matches are then processed and scored where matches in normal text, matches in H4 sized text, matches in H3 sized text, matches in H2 sized text, matches in H1 sized text, page rank, and penalizing of pages that may have attempted to cheat are all considered. Next, the system proceeds to step 196 where the pages are sorted then presented to the searcher at step 198 then proceeds to step 200 to determine if the search result database exists. If yes, the results of the search are stored in it at step 204. If it does not exist or the results were stored in it, the search process ends at step 206.

The present invention is more specifically described below to assist in better understanding the invention. In general terms components of the present invention to maintain accuracy may include: a system to build the directory database containing accurate key words, site functionality, and user ratings; a system to accurately rate and monitor sites or data in the directory database and prevention of fraud; and a system to build a synonym database containing both accurate synonyms and combinations of search phrases that are similar and would produce similar desired content during a search.

Components of directory database 22 system may include: Software used by administrators to manage categories, allow administrators to approve or edit site entries, and the like.

A directory database containing information about sites or data entered.

Software that allows site visitors to enter site or data entries into the database for approval.

Software allowing members of the site to rate sites or data such that the rating is stored in the database.

The directory database may allow access from the search component of the system to certain information. And, there are three types of personnel roles including directory administrators, members of the site, and users of the site that enter site or data information. Not only will the present invention search results include more relevant data while leaving out data that is not of the type that the searcher is looking for, another strength is that it may be configured so that the directory webmaster or staff will have some control over the proper key words and site roles that may be included with the listing. It is expected that this will prevent the webmaster from trying to cheat the system. This control over key words and site roles will also allow the search engine to determine what key words and roles are appropriate to each page.

The present invention may also make all pages on a site equally important and will not make the home page and pages linked to from the home page of a higher value than those listed further down in the site link structure. Many times the information on the home page is more of an introductory purpose and does not have detail which is more likely to be what the searcher is looking for.

The system of the present invention may be configured to provide for each of the following: sites and web pages categorized by functionality or role which, for example, would indicate whether the page or web site is informational in nature or rather be selling a product, whether the site has audio streaming, video streaming, a forum capability or other capability; site ratings by site users to aid in determining the presentation order of matching web pages for the person performing the search; and

a user interface that allows for a user to optionally select the type of function or role they are looking for whereas site pages that do not match the function or role will not be returned as a match in the search.

Optional functions of the system may include:

A user interface to allow a user to turn off or turn on the use of synonyms and similar search phrases during the search.

Use of key words for the site or domain listed in the directory database of sites. When the site is submitted to the web directory, the webmaster may provide key words associated with the site. If the directory editors agree with the key word match and allow the key words into the directory database, the search will be influenced by these keywords. For example, if a site key word includes “cars” and someone searches for “car engines”, pages on the domain that have the word “engines” but not the word “cars” will still match “car engines” because the domain is associated with cars.

A category metatag may be used to further determine the subject category to which a particular web page and site belongs. This tag should match the category where the site is listed in the directory database.

A role metatag may be used to specify which of the roles, the particular web pages are providing. This will help during the search to determine if a particular page matches a role searched for. Only one role would be allowed per page. The role metatag would also be an additional control to help prevent webmasters from being fraudulent. If the role metatag is not included in the directory submission or not accepted by the staff of the directory site, the use of that role tag on the crawled site may not be accepted. If the role metatag is not used on the page by the webmaster, the role value set for the page will be the site prominent role value which is set when the webmaster submits their site to the directory database.

Similar phrases or synonym matches may be used. Many phrases or words have other similar phrases or other words meaning the same thing so expanding the search to include similar phrases or synonyms could help the searcher find more of the information they are looking for. This should be an optional feature since the searcher may be looking for an exact phrase or word match.

Keywords listed for the site in the directory database may be used to prevent fraud by webmasters since if the website category or keywords are not accepted by the directory staff and used by the webmaster of the site, these keywords could be ignored by the web crawler. The use of keywords in this invention is different than the current use on the internet. Normally the keywords used in the metatag must exist on the page but in the use associated with the invention, the key words do not need to exist on the page. The keywords on the page must have been accepted by the associated directory administrators as valid for the listed web site associated with the page.

There are several possible configurations of systems to practice the present invention. Search engine 24 or directory search function can utilize the directory database 22, search term and synonym database 48, and the database of cached web pages 40. The search performed by a user looking for information. Optional page match database—includes page rank relevance information based on various popular searches, possibly contains popular searches matches to scores for each page.

In use, the present invention is a system that allows for the interaction of many people although the primary user of the invention is the searcher (see FIG. 1). The people using it may include a searcher, webmasters, directory administrators, and search engine administrators. The directory administrators manage the directory and approve or remove sites as they are submitted to the directory. A special class of directory administrator may rate sites and be monitored by other administrators. Search engine 34 administrators could maintain the search engine 34 and set optional settings, which may affect how results are returned to the searcher. The searcher may provide search information to the search engine, which will search its database of cached web pages 40 and return results to the searcher.

FIG. 4 provides an illustration of a possible directory utilizing the present invention, parts of the data used by the search engine, and the roles of people who use the directory. The directory may provide the ability for qualified members to rate sites that are listed in the directory. This provides a more accurate human rating of site value rather than a computer generated estimate. This value is used by the search engine to adjust the page placement for pages listed on each site which are evaluated relative to the search term. The site value and page placement tradeoff may be adjusted by the search engine using several formulas and the formulas may be modified at different times.

Since the directory requires members to add site rating values to the directory database, the directory may also provide the ability for members to control private information including changing the member email address, changing the member login password, and any other optional personal information including phone number, biography, member signature, and any web site name the member is associated with. This capability is provided by the directory site programs.

The directory provides the ability for regular members to add sites to the directory, modify site listings for sites they added, and rate sites.

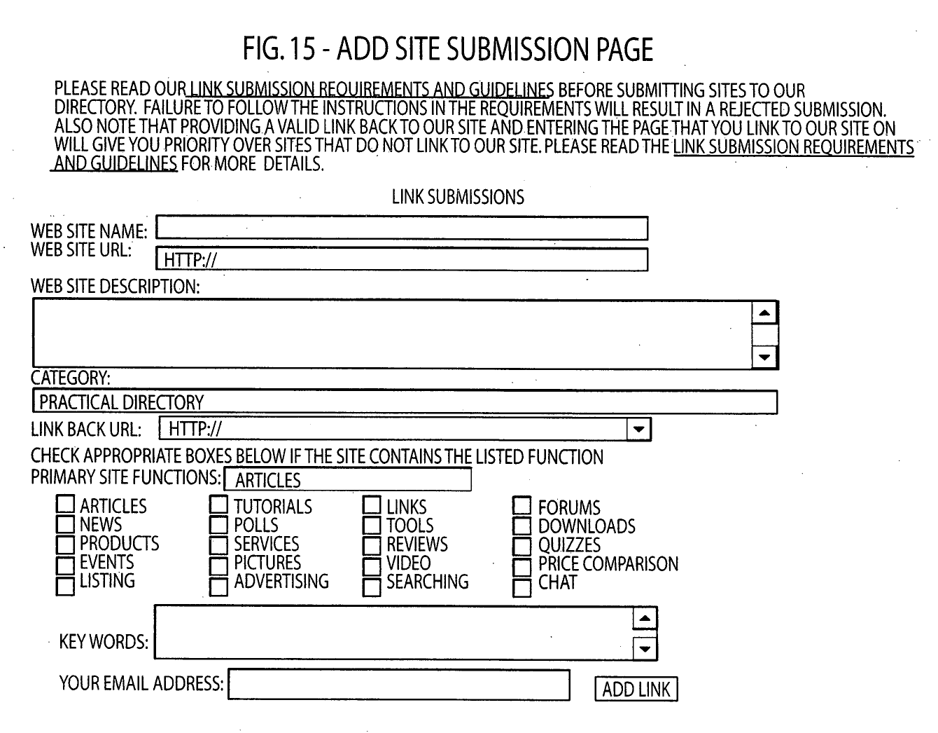

The directory provides the ability for senior members to do everything that regular members can do, but senior members may also view information about other members, approve or reject site submissions (see FIG. 15), edit site submissions, edit member information, set or remove a recommendation for sites, view other member's times they were last active on the directory, view other members ratings of sites, and view members who are suspected of having multiple accounts. Senior members must abide by the policies of the directory especially including privacy policies. Due to the privileges the senior members have, they should be trusted known individuals and should sign an agreement not to violate the policies of the directory site.

Site ratings and fraud control. By allowing qualified members to rate sites, the directory could be configured to assume the responsibility for reducing any fraud and biased ratings of sites. The directory may use several policies and methods to do this. Several types of fraud attempts may include:

Creating several memberships on the site.

Rating sites a member may be associated with high numbers and rating sites that that compete with it with low numbers.

Having friends create memberships and rate some sites well while rating others poorly.

Ways to reduce fraud may include:

Monitor patterns in ratings to determine if there is a tendency to rate some sites high while other sites are rated poorly.

Determine if a person has created duplicate memberships by monitoring the IP addresses members log in from and finding matches between members. This is no guarantee of fraud but may help find some possible fraudulent activities.

When a member logs off and then back on, use cookies to help determine whether the member has multiple memberships.

Record the ratings of all members which will allow for examination, modification, or removal at any time.

Possible multiple memberships are brought to the attention of senior members by the system, who may optionally take appropriate action possibly including removing member site rating privileges, deleting the member, suspending the member, and/or deleting the ratings the member has previously made.

One other optional item to consider for site ratings concerns the age of the site rating. Some members who rate sites may leave or become inactive over time. Over this time the webmasters of the sites may work to improve their content to get a better rating. It is worth providing for the capability to track the last date members were active and track the date the rating was set or last time it was updated. When ratings are older than a set period of time and the member has not been active for that period of time, the weight of the rating relative to newer ratings may optionally be reduced at the discretion of the directory webmaster.

Once a directory site is developed, a directory database may be created, and the code is in place to manage members and allow for administration of the directory, the directory site owner will begin to recruit other trusted administrators or administer the site themselves. The system will give appropriate permission to administrators so they can create sections for links to be placed in, add or remove additional lower level members, monitor member activity such as how they rate sites, and approve or reject the submission of sites. The administrators may also be allowed to edit sites, and categories in the directory.

Administrators may be given the option to recruit and add a regular member to the directory membership or they may approve members when they ask to join. The regular members will be able to rate sites on the directory. As regular members rate sites, the system will allow administrators to monitor for any unusual trends in ratings such as when members tend to rate some sites with higher than normal ratings and others with lower than normal ratings. One item to indicate possible fraud is a larger than normal standard deviation for rated values than other members may posted.

Another possible indication of fraud may be suspected when a member tends to rate sites more than a certain number of points above or below the average value of other members. Code could be put in place to help administrators see these trends and take appropriate action along with code to find members who create more than one account. Cookies and IP addresses of members could also be used to find members who create multiple accounts in a possible attempt to commit fraud.

The system may be configured to allow members of the public or webmasters to add their sites to the directory database by navigating their browser to the add site page on the directory. They will enter their site URL indicating the main domain of the site. They will also enter the name of the site and a sentence or two describing the site which is the web site description. They will choose and indicate the category they believe the site belongs in with a drop down box selection. They will choose a primary site function or role, and other functions or roles that the site supports. They will select and type key words that are associated with their site in a text box with key words or key phrases separated by commas. The person submitting the site will enter any link back URL, enter their email address, and click the submit button on the add site page. The submission program will check the submitted information and add the site entry to the database if no problems are found with the entry.

When an administrator with the ability to approve the site logs into the directory membership area, the site program will indicate there are sites available for approval. The administrator will click on the link to the approval page, which indicates sites are available for approval and a listing of sites with the URL, title, description, keywords, category the site is in, and site roles will be listed. The system will allow the administrator to have links available that allow them to edit any site entries from the site approval page. Once any necessary editing is complete, the administrator may approve the site. The system will automatically send an e-mail to the person who submitted the site indicating the site submission was accepted.

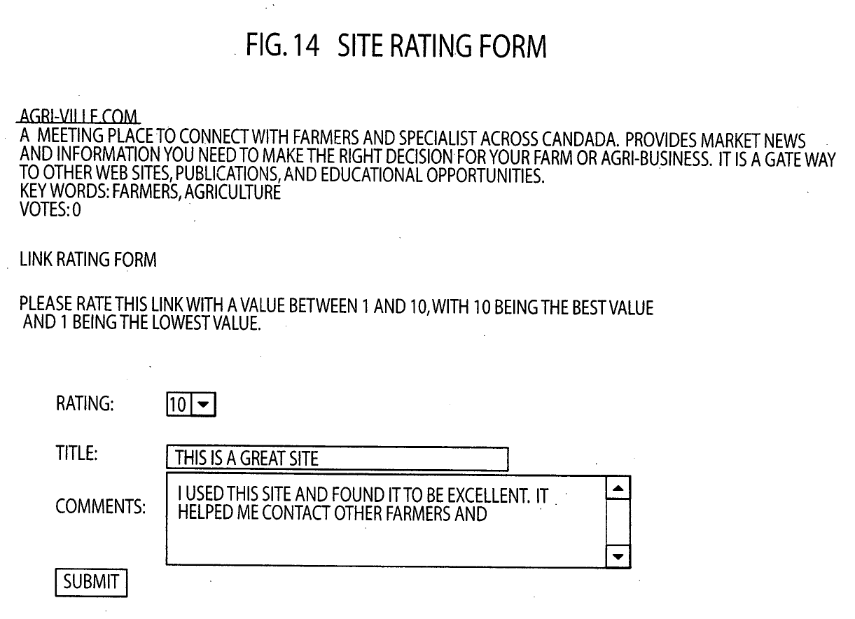

The system's directory database allow growth as administrators add categories to the database, webmasters or others submit web sites, and members of the directory rate sites. The site rating form (see FIG. 14) may include the name of the site with the site description and a link to the site. The rating form may include a rating scale on a scale of one to ten or may optionally include other scales. It may also allow for a comment and comment title to be presented with the rating so those viewing information about the site may later read the reviews. Administrators of the directory will also be able to periodically set random score values for sites that have no votes. This will enable sites not yet rated to have an even chance of exposure to the public. The rated value of the site and therefore its subsequent page values will be calculated by using an average of all votes in combination with a random score value for the site similar to the value used for unrated sites. This random score may be modified periodically when the score for sites with no votes is modified. As the site is rated more times, the random score value will have less effect on the total score for the site. Therefore, the site value may be rated by the system as follows: the site value=(sum of all ratings+random value)/(total number of ratings+1). The variable in the database that stores the rated value calculated as shown may stored as a real number and may have, for example, at least eight significant digits. This will help keep all sites from having exactly the same rated value. The ratings value may be an integer number between 1 and 10, and the random value is a real number between 1 and 10 with a possible fractional content.

The system may allow high level administrators to use the code on the site to monitor for patterns of site rating abuse and remove members abusing the system along with their rating values.

The search performed by a user looking for information: When a searcher looking for information navigates to a page with a search field box, the search process of the present invention begins. The search field box may reside on an internet search engine web site or other search mechanism. The following is an illustration of how the present invention may be deployed.

Search criteria: The system will allow a searcher to optionally make several selections to specify the search criteria although the system will use default values and the last used settings to make the process more user friendly. These include the search phrase, optional advanced features, page roles with the default to select all page roles, page category with the default to select all categories, and an optional selection of synonyms with the default setting to use synonyms. The searcher may enter a search word or search phrase in the box. They may also optionally select advanced features which will allow searches for exact matched phrases in combination with the existence of other phrases or words that are not exactly matched. For exact match phrases, similar phrases are only substituted when the searcher selects synonyms and an exact equivalent phrase can be found in the synonym database. In addition the searcher may select the roles or functions for the types of pages they are searching for. The searcher will optionally be able to specify a directory category to find pages matching the selected category. The default will be all categories and this feature will allow the searcher to further refine their search to sites only dealing with specific subjects. For example, a searcher searching for an operating system (such as one sold under the trade name LINUX) information will probably not be interested in seeing results returned from pages dealing with arts and entertainment. The searcher may optionally allow synonyms or similar search phrases to be included in their search by checking or un-checking a box. Once the searcher enters their search query, selects the type of roles to be included in the search, and determines whether synonyms or similar phrases are to be included in the search, they will submit the information to the search engine or search device.

Search processing: With the preferences and search information provided by the searcher, the search engine or search process will begin (See FIG. 5). If synonyms are selected for use, the search criteria are sent to the synonym database and appropriate synonyms and search phrases are added to the search criteria. Then a search of two databases is started if both are available. The first database is a search results database which stores the results of recent searches to reduce the requirement to search the second database. This database is an optional database and may not be supported by the search engine. The second database is the database of cached pages. The search will begin a query of both databases at the same time. If the search results database exists, and a match with the current search is found results will be presented to the searcher from that database and the search of the database of cached pages will be aborted.

If the search results database does not exist or no results are found in it, the search process will search the database of cached pages to find matches that correlate to both the search term combined with equivalent search phrases and the site or page roles. If a page does not have the proper page role to match the search query, it will not be included in the search results even if it contains a match based on the text words in the search string. Likewise, the page must have the proper category match if the searcher is considering the category the page is listed in as important to the search. This feature can greatly reduce returns that do not match desired results. The text stored in the database must be text that is viewable on the page in question. For example, viewable text may be based on the color of the text compared to the background color of the field behind the text. If the background color and text color are the same or very close, the text will not be considered to be viewable. In addition, sites that try to get their text to be considered to be viewable when it is not by covering it up or using color combinations not detectable by the software performing the evaluation may be banned from searches and providing search results.

A search match may be dependent on the combination of the font size of the viewable text that matches the search phrase, the total number of matches with the search phrase, and the number of words on the page. If the number of matches with the search phrase is too high relative to the total number of words on the page, the search match score of the page may be reduced or eliminated (changed to 0) depending on the settings provided by the web site managers. In addition, this event would be noted in the database for manual review later to consider banning the site or not penalizing the page if the excessive search match was justified. The matches are scored or sorted according to the strength of the match possibly considering where the match occurred on the searched page or data. Matches may be scored higher if they occur in headers rather than in normal sized text. What is considered a header or normal size text may be adjustable by the administrator of the search engine or search device. If the match was in the header, the match will have a stronger score than if it was found in normal sized text. The system may allow the administrator of the search engine or search device to determine how matches are weighed depending on whether the text match was in a header, the size of the header the match was found in, and the whether the text was in normal size text. Also the administrator of the search engine or search device will determine whether and how much it matters whether the match was found based on the original search phrase or based on an equivalent phrase or synonym. The match will also be affected by the site reputation or rated value as provided by the directory database. The administrator of the search engine or search device will determine how much site rating will affect the search match strength for pages relative to the strength based on page content.

Alternate text for graphic images may also be considered when looking for matches on the pages. It may be considered equal to a font size determined by the web master of the site performing the search whether it be a directory, search engine, or another site with the search capability. Link text may be considered to match similar to a font size determined by the web master of the site performing the search. The text used with links that link to the page will not be considered nor will the name of files, domain names, and folders that are part of the path to the web page in question.

A partial match may be considered for a search phrase when part of the phrase is found on the page and another part of the phrase is a keyword associated with the site or web page being considered. For example a search may be done for “LINUX commands” and a particular web page may talk about commands. If the page is on a site that has the key word “LINUX” associated with it or the key word “linux” associated with the page then each time the word “commands” is found on the page, it would be considered to be a match with “LINUX commands”.

Effect of site rating on search match display order: The display order of web pages listed in response to a search may be configured to be determined by two primary characteristics. First, how close the searched web page matches the search which is the overall score of the page for the search. And, second the perceived quality or rated value of the web site that hosts the web page. The weighing of these two may be adjusted by the webmaster of the site performing the search.

Site roles: When a person does a search, the system may be configured to allow them to specify the site role or site purpose they are looking for such as “products” or “tutorials”. A metatag on the page may be used by the webmaster to indicate which site role the page is associated with. The metatag used on the page must match one of the site roles associated with the site in the directory database. If the site role metatag is abused by the webmaster, the site may be penalized or banned from the directory and/or search engine database. The web page with the site role metatag will not be required to contain the site role term on the web page. An example of a site role metatag is shown below as follows: <meta name=“role” content=“products”>.

When a search is completed, the system could allow the user performing the search to check the site role or roles they are looking for. The search engine or web site performing the search may use cookies to store the site roles the searcher is looking for. This is done so the user would not need to enter the desired site roles every time they do a new search. The site roles they last looked for would be set in the search criteria by default. When the search is done pages that match the site role or pages on web sites that match the site role may be considered for placement in the search results. Pages that do not match the site role or are on a site that do not match the site role in the directory database will not be considered in the search results. Webmasters may be encouraged to use the role metatag on their pages by giving their pages a slightly higher match boost when they contain the role metatag. This may be done to offset the fact that pages with role metatags are eliminated from searches that do not match the role. Therefore placing the role metatag on a page may be considered a disadvantage.

Site categories: When a search is done, an optional part of the search criteria may include the site category. This could be the main category where the site is entered in the directory web site database. Even if the site is listed in a lower level subcategory, the category that counts is the highest level category in the database. For example, if a site is listed in a subcategory under “hardware”, which is in the main category of “computers”, then the site category will be “computers” for the purposes of searching using the site category. When pages from the site are listed in the cached page database of the search engine, the appropriate main site category will be included with each page entry. The ability to search based on categories will make the search results much more accurate by eliminating results in areas that are not actually part of the subject area that the searcher is interested in. The database would have its main categories structured carefully to prevent the elimination of content that the searcher may be interested in.

Synonyms: The synonyms database could be used to expand the searches done by internet users. There are many highly searched for and popular words used on the internet. For example, the word “tutorial” is a popular search term. If someone is looking for a tutorial, it would also be relevant to search for guide, manual, and document. Therefore these words would be in the synonym list with “tutorial”. In addition some users may tend to search using less popular words such as “guide”. The word “tutorial”, could conversely be listed as a synonym for guide, manual, and document. Therefore when a search for any one of these terms is done, pages matching any of the terms would be considered to be a match. The original search term may be optionally considered to be a stronger match than those using synonyms.

The synonyms could be used in all searches by default, but the user would be able to optionally turn off synonym matches. The synonyms to be used in the search may be listed for the user and the user may optionally be given the ability to disable some or all of the synonyms.

More accurate searches: The combination of the use of site roles for eliminating pages that do not apply to the search and using synonyms to allow additional pages to have relevance in the search will together produce a more accurate search result.

Once the search engine finds the relevant matches, it may next sort them based on the weighting predetermined factors set by the administrator of the search engine or search device. These factors may include the strength of the match based on text size on the page and the rated value of the site the page was on. The search engine or search device may then produce results sorted by best match to the searcher who performed the search. The searcher will see a list of links with titles pages based on the title metatag of the page as listed in the search engine cache database of web pages. If there is no metatag on the page with a title, the URL of the page will be used for the title. A description of the page will appear below the URL link to the page. The description will be based on the description metatag used in the header of the page and its length will be limited to a number of characters set by the webmaster of the search engine web site. The searcher now has enough information to choose pages to view based on the search.

The search results may be stored in an optional search results database to be used to support other searches for the same information.

Steps to configure the system of the present invention: Configuring a directory database may include information input from four groups of people. FIG. 4 shows the relationship of the groups of people to the directory exclusive of the programmers. The first group may be the programmers that create the programs used to create and manage the directory database. The second group may be the webmasters who submit their sites to the directory. The third group may be the high level administrators of the directory and they will edit, approve, or reject site submissions from webmasters. The fourth group may be members or standard level administrators in the directory who will use the directory but also have the special status of being able to rate the value of the sites listed. The high level administrators of the directory may choose the members who rate sites in an attempt to prevent fraud. They may also monitor the ratings of the members to determine whether any member may be biased. The system could be configured to provide software for recording member ratings to track them and will also list members based on the statistical standard deviation of their ratings. The general rule could be that a large standard deviation may indicate bias since the member may be rating sites that they are associated with using a high number and rating competing sites with a low number.

The building of the web directory database begins with the programmers creating the database and programs to hold the information about web sites and categories they belong in. The web directory database must support the ability to easily allow administrators to create categories and subcategories in the directory. Each category must have a minimum of a name used for the title of the page, description used in the description metatag, parent category, keywords, and location from the site home page where the category page can be found, and the number of links in the section.

A table in the directory database for including links may also be created. This table could include a location to store the URL for each submitted site, the site title, the site description, a flag variable indicating whether the link is approved, a flag variable indicating whether the link is active, a location to keep the number of votes that have been cast for the site, a location to keep the sum of all votes cast, a place to keep the total score which is the sum of all votes cast divided by the number of votes, a value to indicate the category the site is listed in, an unique site identifying number, the primary role of the site, and the keywords appropriate for the site. An additional table could hold information about other roles that the site provides.

A table in the directory database for member information must also be provided. This table may include a member login name, member password, and a variable to provide for member type or member level which will control the access level of the member. Most members will be limited so they can only rate sites. There will be several levels of membership with higher level members having more privileges. The directory could provide for keeping private information about members private so items like email may only be viewed by other members when the member whose information is viewed wants to allow it. The administrators of the directory with the highest privileges may be able to view this information also.

A separate table may be used to control permissions to various directory site capabilities including rating sites, approving sites, de-activating sites found to be inactive, re-activating sites, adding categories for sites to be placed in, adding new members to the site, and editing current member information.

Another required program the directory database may use includes a very simple link checker that will try to load the main pages from websites listed in the directory. This program could run periodically and check a preset number of sites every time it is run. It will look for a successful page load. If it does not get a successful page load, it will increment a value indicating a page load has failed. If the page loads successfully, the bad page load value will be cleared back to 0 to show the page is available. This program or companion program could also check for exact copies of the site main page against other site main pages. If a match exists, it would indicate that a webmaster may have used an alternate domain name for the same site to get an additional listing in the directory. The program should set a flag on the two websites indicating that they have matching main pages and allow the administrator of directory to take appropriate action. The flag may indicate the link ID of the matching website.

Once the directory database structure and code for managing members, categories, sites, and site ratings is complete, the building of the web directory database continues with directory administrators determining categories and subcategories included in the database. Websites will be listed only once in one of these appropriate categories. The directory administrators should not create or be concerned with having a category included that is the same as one of the site roles or functions. For example, of one of the site roles includes “forums”, there should normally not be a database category called “forums”. If a site role includes tutorials, documentation, articles, or information, there should normally not be a site role called documentation. The subject of the site such as animals, technology, economy, or other area is the only concern.

The third step in the building of the directory database concerns webmasters submitting their sites to the database. Webmasters will choose an appropriate category in which to submit their site along with choosing all the site roles their site provides. Webmasters may also need to choose the most appropriate prominent site role for their site. This role could be used to set pages on their site to that role value where a role metatag is not included. Webmasters may also choose keywords that apply to their site. Webmasters should carefully select these keywords and site roles since they will be very important later when deciding if their site pages are relevant during a match search. Webmasters may only be allowed to submit their site once to the database and only in one category so the category selection should be carefully chosen. The software allowing site submission should check to see if the website already exists in the database before adding the submission. Webmasters may need to come back later to update the site roles and keywords as their site changes.

The present invention could allow for directory administrators to review site submissions provided by webmasters and determine whether the submissions are appropriate with the category, role, and key words. Administrators may edit the submissions as necessary and either approve or reject the submission of the sites. The directory database may have the option of not listing sites of a specific category or type such as gambling or pornography along with the discretion to determine that a site does not have enough value to list.

The fourth step in the building of the directory database of the present invention involves the rating of sites in the database. All sites that are submitted may have an overall value score. The value score will later help determine the order of the sites web pages returned for a search. Sites that have not been rated by a human may be assigned a random value score. This unrated site value score may be changed for all unrated sites on a periodic basis such as weekly. A random value score will allow for unrated sites to have a fair chance to get exposure and traffic from visitors. The database may support a minimum of 8 significant digits for the total rated value to allow different websites to have a lower chance of matching the exact value of the rated value of other websites. The rating that the rating member supplies may be a value from one to ten or it may include a rating of every site role listed in the database. For example if the site provides tutorials and products, users of the site may rate the tutorials and products on the site individually so that each may receive a different rated value. This option will be determined by the directory administrators.

Directory members selected by high level directory administrators may have the ability to rate sites. Directory members must be unbiased and honest in their evaluation of sites. Directory members will be typically selected from members of the public who would be likely users of sites listed in the database. They may or may not be paid for their services to the directory. Ratings by directory members will be recorded in the directory database and their votes can be evaluated to determine where there is any reason to suspect bias.

The directory database may also be able to find dead links and allow high level administrators to remove or de-activate entries to sites that are no longer functioning. The directory database may also allow users of the directory to report links that are dead or redirected to a site that is not the original type of site listed. This may happen when a domain goes dead, then is purchased by another company for a different purpose, and the site content is not appropriate to the original listed category anymore.

The invention may be used by a search function on a website or internet search engine although its use is not limited to these two types of sites. The search function or search engine may be enhanced by a web page crawler that could create a database of cached web pages from information provided in the directory database. Once the database of cached pages is created, it must be made available to the search function code along with the database of similar search terms and synonyms. The creation of the search capability would involve the creation of software that can accept a set of search criteria from the user, properly access several databases in a timely fashion, sort returned results, and present them to the user. An additional search result database may be used to support and increase the performance of the search engine. This database would store search results previously within a set period of time. Another possible performance enhancing solution may include the creation of a separate database from the cached database with scores for each cached page based on all possible searches.

The search engine using this configuration may need the ability to query the search result database to determine if a stored search is available and present the stored search to the user if possible. It could query the search result database at the same time it queried the synonym database and build the search criteria for the search of the database of cached pages. If the search result database returned no matching results and synonyms are received, it could query the web page cache with using the original search terms and synonyms combined. Pages that do not provide requested site roles would be excluded from the list of returned results. When or as results are returned, they would need to be sorted based on the original site rating in the directory database, and relevance of the search phrase or synonyms that are found on the page. Key words associated on the site may also be used to weigh the search results.

The building of a database of cached web pages from sites listed in the directory database. The system may require a program that follows links through the network or internet and finds pages on sites that are listed in the directory database. This program could be called a robot crawler or site caching robot. It would periodically crawl sites listed in the database and add pages on these sites to a database of cached pages. FIG. 6 shows the robot crawler relationship with its data sources and what the robot crawler does. The robot crawler and database of cached web pages will deal with issues such as duplicate URLs, norobots tags, metatags, link path, and storage of site rating value. The robot crawler may not crawl sites not listed in the directory database. If sites are crawled that are not listed in the directory database it would be difficult to determine site roles, valid key words, and site value so it is not a good idea to crawl sites that are not listed. The site crawler would need to determine pages that have URLS appearing different but are actually the same and only cache the information for one URL. For an example of this, consider the fact that when viewing a directory, there is a file that is displayed by default by the site server computer. Usually this file is called index.html or default.html. Therefore, for example, the URL of http://www.[domain name].com and http://www.[domain name].com/index.html may be the same page. The crawling robot would need to make this determination and only cache one page in the database of cached web pages.

The robot crawler would need to find pages without crawling duplicate links. Therefore pages that are already crawled during the current session could be marked. A database separate from the directory database or cached webpage database may be used to store temporary information for the robot crawler. The robot crawler could crawl links to other sites from the current site being crawled but this would not typically be the case since all crawled sites should be listed in the directory since site keyword and role information should be provided by the directory database to the crawler. Therefore the site crawler would typically ignore links to other domains and go back and read the directory database to find a new domain or website to crawl once it has completed crawling any given site or domain.

The robot crawler would need to honor the norobots tag provided by webmasters and not crawl web pages labeled with this tag. It may also need to be able to utilize an algorithm that will enable it to find all pages on crawled sites and determine whether it has crawled all pages it is allowed to crawl to avoid looping randomly and indefinitely through the site. The web crawler will not need to follow external links to other sites or domains.

The robot crawler may determine whether key word or role meta tags used on individual pages are valid by reading the keywords and roles in the directory database that are associated with the site being crawled. If they are not listed in the directory database, the keywords or role metatags should not be accepted by the crawler.

The database of crawled pages would have each page associated with the identification of the particular site the page is listed on so it would be easier to get site value and site role information from the directory database quickly. The robot crawler could also determine what appropriate role each crawled page is associated with and store that information in the database of crawled sites. The robot crawler will not store markup tags in text but will only store text based on header size and type into the database for each page marking the type and or size of text for later weighting in search queries. The robot crawler may store accepted metatags for each page.

The robot crawler may also store the associate site rated value for each crawled page which would aid in later searches since the pages could be more easily sorted when this value is included in the cached page database.

The robot crawler may also need to strip any HTML or XML tag information out of the information being stored. It could store the header content of the page based on header size in one field of the cache database and normal text size content would be stored in another entry area of the cache database. For example, there may be entries areas in the database for headers of the largest size (H1), along with H2, H3, and H4. There is also a storage area for normal text. The crawler will load the page, and then evaluate its type. If it is plain text, all the content will be stored in the area for normal text. If the page type is HTML, it will remove HTML tags while evaluating and storing the contents of the page. The crawler may need to consider not only text specified as headers using HTML tags, but also consider other means of specifying larger than normal size text. The crawler will need to consider text size specified by cascading style sheets whether the style information is stored on the HTML page being stored, or whether it is external to the page.

The robot crawler may need to store all text content from crawled pages in all lowercase or all uppercase letters so search results are not missed because of mismatch of the case of letters between the search term and the cached database. The search term used will also need to be all uppercase or lowercase matching the case of the cached data. Lowercase will be the preferred method.

The robot crawler will need to consider whether text is being hidden by using the same or similar colors for both the background color and text color. If this is found the webmaster of the directory associated with the crawler should be notified, possibly by setting a flag in the directory database for the associated site.

The building of the database of cached web pages could be done on a periodic cyclic basis. One cycle could be the complete crawling of all sites listed in the directory database. The cycle time may vary in length depending on the preferences of the search device administrators, the number and size of sites to be crawled, and the speed of the equipment available to do the work. FIGS. 7 through 12 show a flow chart of an example of a robot crawler caching web pages from web sites that are listed in the directory.

The robot crawler in this illustration begins the cycle by copying a listing of all sites and useful information from the directory database for the purpose of building a cached database of web pages. The information is copied into a temporary cycle database. It will copy the site listing category, site key words, site roles, and site ratings from the directory database. This will provide easy access to the information without overloading the directory database and will lock the information down so it cannot be changed during the web site crawl cycle. The robot crawler program will include two additional flag variables in the temporary cycle database which will help it with the job of crawling the directory database. The first database field will indicate whether a site has been crawled or not. The second database field will indicate whether the robot encountered an error on the site that prevented if from crawling the site completely. A third optional database field will indicate whether the webmaster of the site attempted to use keyword meta tags or role meta tag not listed on the directory. A fourth optional database field will indicate whether the site webmaster attempted to hide content in any manner such as placing text on the same color background. A fifth optional database field will indicate whether the site webmaster had extra high key word density on any pages on the site which indicates a possible attempt to create spam pages for specific search terms.

The crawler can get the URL of an uncrawled site from the temporary cycle database. The crawler will create a temporary site or domain database for the site containing fields with a URL for each page, a processed flag indicating whether the page has had its internal links added to the temporary domain database and has been cached, a data type field such as normal text, H1, H2, and H3 for various header sizes, the page role, page category, site key words, a flag value indicating the location where the page role was derived (1=page metatag, 2=first directory listing), the rated value of the domain associated with the page, an error flag indicating the page was not able to be loaded, a high keyword density flag, and a hidden text flag. The normal text and H1, H2, and H3 fields are where the content from the page will be stored. Most of these fields are also included in the cache database excluding the cached flag and index flag. The robot crawler then begins crawling each page in sequence using the following method. The crawler will put the main page of the domain or site being crawled into the temporary domain database of pages. It will store data for the page in a table containing the URL string, and a processed flag, indicating whether the page has had its internal links added to the temporary domain database and has been cached. It will then get the first uncrawled page from the list and crawl the page and others using the procedure explained in the following paragraphs.

The crawler may attempt to load the page from the site or domain. If an error occurs, it will try to load the main page of the domain to determine whether the site is down. It may attempt this several times. If the attempt to load the main page is successful the crawler will mark the current page it attempted to load with a load error flag in the temporary domain database and it will not be copied into the main cache database later. If the attempt to load the main page was unsuccessful the crawler will increment an error flag in the temporary cycle database and abort the crawl of this domain or site for now moving on to the next site listed in the temporary cycle database.

If the page is an HTML, or XML file, it will get all links on the page and put them in a temporary table. For each link on the table it will check to see if the link is in a different domain. If the link is in a different domain, it will mark the link as invalid since it should not crawl links on other domains. The robot crawler will look at the link and determine whether the link can be listed differently. It will check the temporary domain database of pages to see if the URL of the page in question has been listed before during this cycle and consider all possible listing methods. It will search for possible alternate ways to list the same URL. If the link (URL) is already in the temporary domain database of pages, it will mark the link (URL) as invalid. It will then add all remaining valid links on the list to the temporary domain database of pages creating a unique ID value and add it to the list of unique URLS.

The crawler may search the page key word metatag for key words and compare them to the key words listed in the temporary cycle database. It may either remove key words not also included in the temporary cycle database or not cache the page into the database at the discretion of the staff administering the search device or search engine. If key words were included in metatags that were not listed in the temporary cycle database, it will set a flag in the temporary cycle database to indicate that. The crawler will look for the page role metatag. If the page role metatag is found, it will check to see if only one role metatag value is included. If only one role metatag value is found and the directory database has that value included, the value is stored in the page role string and the flag value for where the role was derived is set to a value of 1. If the role metatag exists and is not listed in the directory database, a blank value is stored in the page role string. If the role metatag does not exist, the primary role metatag derived for the site is listed for the page and the flag value for where the role was derived is set to a value of 2. The primary role for the site is set at the time of website submission by the webmaster.

Other tasks the crawler may perform include checking to determine whether there is any hidden text on the page and set the flag in the temporary cycle database and the temporary domain database showing the webmaster attempted to hide content. The crawler may also check the page for extra high key word density and set a flag in the temporary domain database and temporary cycle database indicating high key word density for the page and the site.

The crawler may examine markup content that specifies headers whether it be using style specifications as in the case with cascading style sheets (CSS) or using HTML tags. It may categorize all header size content and after making all text lower case, and removing markup tags, store the text in the proper data type storage area for the header size such as H1, H2, H3, etc. All other text not included in header storage areas may be stored in a normal size data area after the text is set to lower case and all markup content is removed. The crawler may also examine the page for a page title included in the metatag area. If one is found, it will be saved in the title field of the page entry. If one is not found, the URL of the page will be used instead. The title field will have a limited number of characters set by the search engine webmaster. The crawler will search for a page description metatag. If it finds one, it will parse the information and save the page description in the page description field for the page entry. If a description is not found, the first text found on the page will be substituted. The description field will have a limited number of characters set by the search engine webmaster.

The crawler may next proceed to cache the page with the parsed information retrieved. It will update the temporary domain database of pages with the new information from the page. The table for the data will include fields with a minimum of the data type such as normal text, H1, H2, and H3 for various header sizes, the value of the item stored which is text string from the page, the page role, key words, a flag value indicating the location where the page role was derived (1=page metatag, 2=first directory listing), and the rated value of the domain associated with the page.

If the page is a simple text file, the robot crawler may change all content on the page to lower case text and store the text in an area in the database for normal text and set the cached flag for the page. The crawler may use the first 40 to 60 characters on a text page for the link title, and the first 200 characters for the page description.

Once all information on the page has been categorized and stored, the page processed flag may be set in the temporary site database indicating the page content has been saved to the database and links on the page have been checked and entered into the temporary domain database.

The crawler may next proceed to crawl the next page listed in the temporary site database checking first to be sure all internal links on the page are listed in the temporary site database. It may crawl all pages in the temporary site or domain database using the procedure in the above nine paragraphs until all pages on the domain or web site have been both indexed and cached. Once all pages on the domain have been indexed and cached, the temporary site database contents may be transferred to the cache database provided no errors were encountered. Only pages that loaded and do not have the error flag set will be transferred. Old pages may be replaced with the information that was just crawled. Any pages in the cache database that do not also exist in the recent crawl are deleted. New pages may be assigned a unique identifying number as they are copied to the cache database. The crawler may next proceed to begin the process again for the next site listed in the temporary cycle database.

Once all sites have been crawled that did not have errors, the crawler will attempt to re-crawl any sites in the temporary cycle database that had previous errors. It will make three attempts over a period of at least three days to crawl these sites. Any partial content will be saved during these attempts. If these sites are not successfully crawled within the time that the three attempts are made, any partial content may be stored and copied to the cache database while old page listings are removed. If no content is found on the site, all content from the site is removed from the cache database. At the end of the crawl cycle information about sites where key word abuse, role metatag abuse, hidden content, web sites that were not working, or other problems can be sent to the staff at the directory site. This can be done using email or by creating a database table with required information and making it available to software on the directory.

Once all sites with or without errors are crawled, the cycle of crawling sites may begin again.

In use, the search engine will begin its work when a searcher enters a search phrase with search criteria at the search page of the search engine or search device. FIG. 13 provides a flow chart of a possible search process. If there is a search result database, it will query that to see if a matching search was done while it builds the search criteria and queries the synonym database if required. The code may first parse out the search string. If the search string is in quotes or an exact match is specified, the quotes will be removed and the string will not be parsed so only exact matches for the string must be found. If the string is parsed, white space such as spaces or tabs is removed from the string and each word is searched for separately. If there is a synonym database, the search engine code will get results from the synonym database and add similar exact phrases or appropriate synonyms to the phrase. If the search result database provides useful results, it will return the results to the user, otherwise, it will continue by searching the cache database of crawled web pages for search phrases that match the searchers criteria. All matching pages must produce at least one match for each word or synonym in parsed search phrases.

The code will search the database for all pages that have the specified page role or roles desired by the searcher and are listed in the desired category in the database. Then the search code will count string matches in returned values checking for matches in several fields including matching normal size text, matching header fields including H1, H2, H3, and other header fields. The search code may also examine key words stored in the database that are related to the web page. The search code may optionally search for matches based on the title of the web page and the description of the web page.

The search code may score search results based on the number of occurrences of search words or phrases in various fields associated with each web page. For example, matches in normal text may count as one point, matches in a H4 field may count as 2 points, H3 field may count as 3 points, matches in a H2 field may count as 4 points, and matches in H1 fields may count as 5 points. Matches in a keyword may count as 2 or 3 points. The search engine staff or webmaster may optionally be able to set the score values based on matches and where they are found. If a search is for “LINUX commands” and the search string is not in quotes or require an exact string match with the site role being tutorials, the search code will first locate all pages that have a role of tutorials. Then it will search all pages for LINUX, and commands counting the number of matches in each field for the word “LINUX”, and the word “commands”.

If any search for any word is not found in any field associated with the page, the page may be dropped from the search. All search matches may then be scored based on the point system above depending on how many matches were found in each field. If a page had one match in a keyword, one match in a H2 field, and three matches in a normal text field, then the total score for the search for that page would be 8 points total. The page would be given additional points based on its rating. The rating is based on the rating of the site or domain as provided by members who rate sites in the directory. Several ways exist to adjust page match for page rank and the preferred method is to add a percentage to the page score based on page rank. For example if the page with a score has a rank of 1, 10% could be added to the score for a total score of 8.8. If the rank was 5, 50% would be added to the score for a rank of 12. The system may optionally provide for penalizing pages with hidden content or too high of keyword match since there is a flag in the cache database to indicate when these conditions occur. The pages could be sorted from the highest score to the lowest score and results presented to the user. The webmaster of the search engine may limit the number of pages shown to the user to a number such as 1000 to keep the search responsiveness quick.

The information presented to the user could include a URL of the page with the link title shown as the page title stored in the database of cached pages. A description of the page may appear below the link and the description may be from the description of the page stored in the database.

The webmaster of the search engine may optionally store the search phrase and search results with scores for each page in a separate search results database. This information may be used to provide results to other users who perform the same search within a set period of time. The phrase with the roles searched for, and an indicator of whether synonyms were selected may be stored in one table along with a unique identifying number used for identification of the search phrase and another value indicating the time the search was done. The matching sites may be stored in another table with the phrase ID and the site ID along with the total score of the search match for each site. The number of matching sites may be limited by the search engine webmaster. Periodically, a robot may scan the database and remove old searches and their search results.

The building of a similar search term and synonym database could involve administrators of the database determining search phrases and synonym words and entering them into the database. They may also need to determine the equivalent search phrases and words and enter them into the database with a central identifier that will tie all search phrases and synonym words together. One common set of synonyms would therefore have a single identifying value. When the search phrase or search word is used, the common value would be determined based on the phrase, then all phrases or synonyms with that same value would be involved in the search. It is also worth considering the possibility of giving results returned based on the original search word or phrase a slightly higher weight than the results returned using the equivalent search phrases or words.

This database would most easily be managed with software that will easily allow administrators to view current phrases and their equivalent phrases. It would also allow the addition of equivalent phrases and check to be sure redundant phrases are not included in the database.

In summary some of the aspects of the present invention involve: Use of user ratings to determine page value rather than robots; Limiting search results based on page or site roles; Limiting searches based on the category the site is listed in; A cooperative role between a directory and search engine or search function; and Use of synonyms to provide more relevant information in one search.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

The claimed invention is:

1. A method of performing a multi-dimensional search with a computer, comprising:
creating a directory database comprising site information, said site information comprising addresses for a plurality of web sites, a role for each said plurality of web sites, and a rating for each said plurality of web sites;
receiving a first query;
performing a search of said directory database based on at least one role for each of said plurality of websites, and at least one rating for each of said plurality of web sites;
obtaining search results from the search of the directory database, said search results comprising an address for at least one of said plurality of web sites; and
outputting the search results.

2. The method of performing a search as in claim 1, wherein said site information further comprises a category for each said plurality of web sites.

3. The method of performing a search as in claim 1, further comprising creating a secondary database, said secondary database comprising a search results database or a cache database.

4. The method of performing a search as in claim 3, wherein the search results database comprises previous search results.

5. The method of performing a search as in claim 3, wherein the cache database contains a cache of web sites from the directory database.

6. The method of performing a search as in claim 1, further comprising checking the validity of web sites, said checking comprising locating web sites listed in the directory database.

7. The method of performing a search as in claim 6, further comprising checking the directory database for repetitive web site links.

8. The method of performing a search as in claim 1, further comprising creating a temporary cycle database, wherein said temporary cycle database temporarily stores a copy of addresses for said plurality of web sites contained in the directory database.

9. The method of performing a search as in claim 1, further comprising a temporary site database, wherein the temporary site database temporarily stores web sites.

10. The method of performing a search as in claim 1, further comprising creating a synonyms database, said synonyms database containing synonyms for potential search terms.

11. A search engine, comprising:
a directory database, said directory database comprising site information, said site information comprising addresses for a plurality of web sites, a role for each said plurality of web sites, and a rating for each said plurality of web sites;
an input device, said input device being capable of receiving at least one search term from a user; and
a search program, said search program being capable of obtaining search results based on said at least one search term, wherein said at least one search term comprises at least one role for each of said plurality of websites or at least one rating for each of said plurality of web sites.

12. The search engine of claim 11, further comprising a secondary database, said secondary database comprising a search results database or a cache database.

13. The search engine of claim 12, wherein the search results database comprises previous search results.

14. The search engine of claim 13, wherein said search results are further based on said previous search results.

15. The search engine of claim 14, further comprising a synonyms database, said synonyms database containing synonyms for potential search terms and wherein said search results are further based on said synonyms.

16. The search engine of claim 12, wherein the cache database contains a cache of web sites from the directory database.

17. The search engine of claim 16, wherein said search results are further based on said cache of web sites.

18. The search engine of claim 11, further comprising a temporary cycle database, wherein said temporary cycle database temporarily stores a copy of addresses for said plurality of web sites contained in the directory database.

19. The search engine of claim 11, further comprising a synonyms database, said synonyms database containing synonyms for potential search terms.

20. The search engine of claim 19, wherein said search results are further based on said synonyms.
